(19) United States
(12) Patent Application Publication
(10) Pub. No.: US 2005/0083187 A1
(43) Pub. Date: Apr. 21, 2005

(54) Flat panel color cluster

(75) Inventors: Vyacheslav B. Birman, Rochester Hills, MI (US); Pavel Birman, Akron, OH (US)

Correspondence Address: SIEMENS CORPORATION;INTELLECTUAL PROPERTY LAW DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 10/941,161

(22) Filed: Sep. 15, 2004

Related U.S. Application Data
(60) Provisional application No. 60/511,689, filed on Oct. 16, 2003.

(51) Int. Cl. B60Q 1/00

(52) U.S. Cl. 340/438; 340/995.2

(57) ABSTRACT

An instrument cluster includes a compact color flat panel display for reducing the “eyes off the road” time of a driver. The display includes vehicle information graphics to convey vehicle information to the driver and a text portion to display communication information, such as telephone numbers of incoming calls. The vehicle information graphics use color and/or shape to convey the vehicle information. As an example, green may indicate a normal or safe vehicle condition, a change to yellow may warn of a cautionary vehicle condition and a change to red may warn of a more serious vehicle condition. Using a compact display and changing colors to indicate a vehicle condition may decrease the “eyes off the road” time of the driver.

The application claims priority to U.S. Provisional Application No. 60/511,689, filed on Oct. 16, 2003.

### BACKGROUND OF THE INVENTION

This invention relates to vehicle displays and, more particularly, to a compact instrument cluster display that uses color to present information to a vehicle driver.

A motorized vehicle typically includes an instrument cluster to display vehicle information for a driver. The displayed vehicle information usually includes vehicle speed, vehicle rotation per minute (RPM), engine temperature, fuel level, battery voltage, and other vehicle conditions. These vehicle conditions are displayed using a variety of instruments. More space on the instrument cluster is used to display the instruments in their entirety than is necessary to display the vehicle condition information.

The large size of conventional instrument clusters leads to long periods of “eyes off the road” time. In order to read information from the instrument cluster a driver must look from the road to the instrument cluster, focus on the instrument cluster, scan the instrument cluster for the information of interest, and read the information from an instrument. Even when a driver knows which part of the instrument cluster to scan, the speedometer for example, it may take extra time to locate the needle pointer on the speedometer scale because the entire scale is displayed rather than only the significant portion of the scale where the needle pointer is located.

One way to decrease the “eyes off the road” time may be to use color to convey the vehicle information. Spatial resolution of the human eye varies significantly within different portions of the retina of the eye. As a result, a driver may not resolve an instrument cluster shape unless he is looking directly at the shape, i.e. by taking his eyes off the road. Color resolution however, remains constant over the entire retina. Therefore, a driver with his eyes on the road may be able to peripherally discern a color on an instrument cluster without removing his eyes from the road to look at the instrument cluster.

Some conventional instrument clusters use color, such as a red portion of an RPM scale, to indicate a warning level. Other conventional instrument clusters use illuminated red or orange colored symbols in conjunction with words to convey warning information. A yellow engine symbol with the word “ENGINE” below the symbol may illuminate from an unlit state when there is a vehicle engine problem. Although a driver may see this type of color information, the color information narrowly conveys vehicle condition information by only illuminating from an unlit state and may be insufficient to determine the degree or extent of the related vehicle condition. Moreover, this narrow use of color may not be adequate to overcome the time it takes to scan the large size of conventional instrument clusters.

Accordingly, a compact vehicle instrument cluster display that more effectively uses color to indicate vehicle information is needed.

### SUMMARY OF THE INVENTION

The instrument cluster display according to the present invention is a compact color flat panel display for reducing the “eyes off the road” time of a driver. The display includes vehicle information graphics to convey vehicle information to the driver and a text portion to display communication information, such as telephone numbers of incoming calls.

The vehicle information graphics utilize color and/or shape to convey the vehicle information. In one disclosed example, a fuel pump telltale is in the shape of a fuel pump and a thermometer telltale is in the shape of a thermometer. The fuel pump gauge is green, yellow and red. As the vehicle fuel level decreases, the green changes to a gray. As the vehicle fuel level further decreases, the yellow changes to gray and as the vehicle fuel level nears empty the red changes to gray to warn the driver of a low fuel level. In another example, a speedometer gauge uses a colored background and a contrasting scale to indicate speed. The color of the background of the speedometer gauge changes from blue at low speeds, to green at higher speeds, to yellow at intermediate speeds, and to red at high speeds. The color of the background may also be linked via a global positioning navigation system to the speed limit on the road that the vehicle is traveling on such that the background is green when the vehicle is below the speed limit, yellow when the speed is close to the speed limit, and red when speed exceeds the speed limit. The color changes of the background may also be linked to driving conditions such as weather and daytime/nighttime wherein green, yellow, or red indicates whether the speed is reasonable for the driving condition.

Other vehicle information graphics on the instrument cluster display share the same area to save space. In one example, a gear telltale displays a letter “D” when the vehicle is in drive and a “P” when the vehicle is in park, but when the “D” is displayed the “P” is not. In another example, a turn signal portion displays a left turn arrow or right turn arrow. The right and left turn arrows are displayed in the same area to save space such that when the left arrow is displayed, the right arrow is not.

In another instrument cluster display example, a remote LED lighting system is connected to the instrument cluster display and alerts the driver to check the instrument cluster display by lighting a green, yellow, or red LED. When all the vehicle information graphics on the instrument cluster display are green the green LED is lit, when at least one vehicle information graphic is yellow a yellow LED is lit, and when at least one vehicle information graphic is red the red LED is lit.

The instrument cluster according to the present invention provides a compact display that uses color to convey vehicle information to a driver.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates a schematic view of a vehicle with an instrument cluster;

FIG. 2 illustrates a schematic front view of the instrument cluster referred to in FIG. 1;

FIG. 3 illustrates a schematic front view of the instrument cluster of FIG. 2 with different variable inputs;

FIG. 4 illustrates a schematic front view of the instrument cluster of FIG. 2 with different variable inputs; and

FIG. 5 illustrates a schematic front view of another embodiment of the inventive instrument cluster.

### DETAILED DESCRIPTION OF THE PREFERRED EMBODIMENT

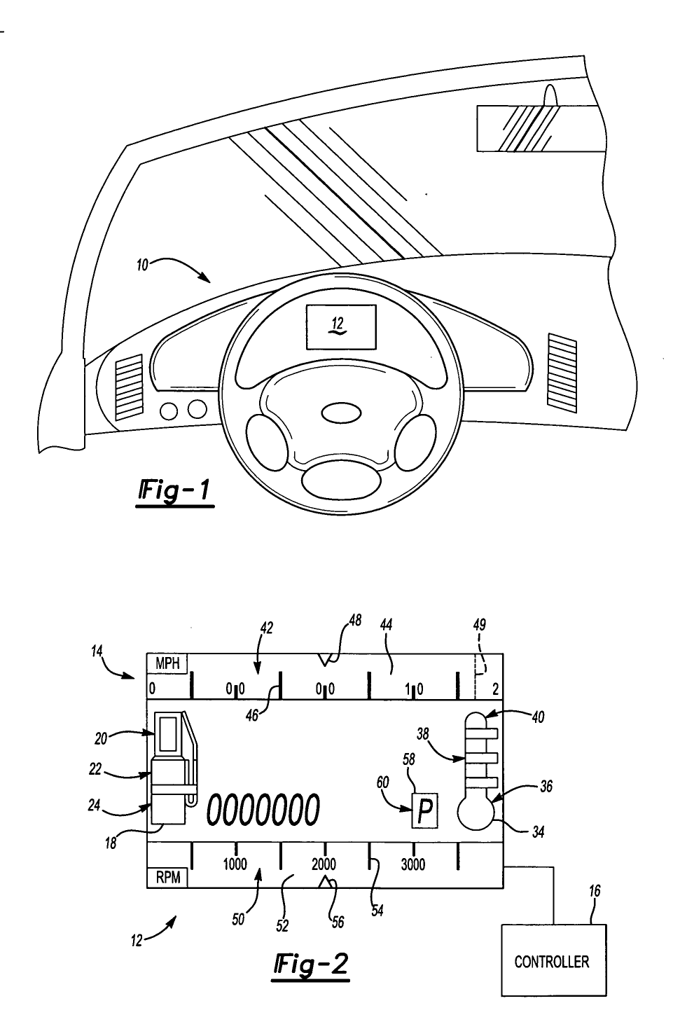

FIG. 1 illustrates a schematic view of a vehicle 10 having an instrument cluster 12 for displaying fuel level, vehicle speed, engine RPM, engine temperature, mileage, the gear the vehicle is in, and other vehicle conditions for a driver. The instrument cluster 12 is a color flat panel display that is compact in size. In one example, the display was approximately between 3.5 inches to 3.8 inches diagonally. The compact size and use of color may provide the benefit of reducing the “eyes off the road” time of the driver, thereby leading to safer driving.

FIG. 2 illustrates a schematic front view of the instrument cluster 12 referred to in FIG. 1. The instrument cluster 12 includes vehicle information graphics 14, which are representations that may include symbols, numerals, letters, scales, gauges, telltales, or other representations that convey vehicle information to the driver. The vehicle information graphics 14 are continuously displayed during the operation of the vehicle such that they are constantly viewable by the driver without having to toggle or switch between complex menus or alternate displays.

The vehicle information graphics 14 utilize color and shape to convey variable input vehicle information that is received from a controller 16. A fuel pump gauge 18 indicates a vehicle fuel level via shape and changing color. The fuel pump gauge 18 is in the shape of a fuel pump to represent the vehicle fuel level. A controller 16 supplies vehicle fuel level information to the instrument cluster 12 to be displayed by the fuel pump gauge 18. The fuel pump gauge 18 is multi-colored with a green upper portion 20, a yellow mid-portion 22, and a red lower portion 24. As the vehicle fuel level decreases, the green upper portion 20 changes to a gray color. As the vehicle fuel level further decreases, the yellow mid-portion 22 changes to gray. As the vehicle fuel level nears empty, the red lower portion 24 changes to gray. Alternatively, the entire fuel pump gauge 18 may change to red when nearing empty. The use of changing green, yellow, and red color indicates the fuel level to the driver without the driver having to actually read the fuel from a scale. Of course, the specific colors are merely examples. What is important is to use different colors and changing colors.

The instrument cluster 12 includes a thermometer gauge 34 that indicates engine temperature via shape and changing color. The thermometer gauge 34 is in the shape of a thermometer to represent the vehicle engine temperature. The controller 16 conveys engine temperature information to the instrument cluster 12 to be displayed by the thermometer gauge 34. When the engine is cold the thermometer gauge 34 is entirely blue. When the engine is warmer, a lower portion 36 of the thermometer gauge 34 is green and the remainder of the thermometer gauge 34 is gray. Green indicates a normal or safe engine operating temperature. When the engine is warmer, a mid-portion 38 of the thermometer gauge 34 changes from gray to yellow. Yellow indicates that the engine temperature may be of some concern. When the engine is hot, the top portion 40 of the thermometer gauge 34 changes from gray to red. Alternatively, the entire thermometer gauge 34 may change to red when the engine is hot. The use of changing green, yellow, and red color indicates the engine temperature to the driver without the driver having to actually read the temperature from a scale. Of course, the specific colors are merely examples. What is important is to use different colors and changing colors.

The instrument cluster 12 includes a speedometer gauge 42 that indicates vehicle speed. The speedometer gauge 42 includes a colored background 44 and a contrasting scale 46. The contrasting scale 46 scrolls relative to a pointer 48 that indicates the speed of the vehicle 10 on the contrasting scale 46. Optionally, a line 49 may be displayed to indicate cruise control set speed. The portion of the contrasting scale 46 that is displayed is only the significant portion. As an example, only about a 30 m.p.h. range of the contrasting scale 46 is displayed and not the entire speedometer scale from 0 m.p.h. to 150+ m.p.h. This may help the driver to read the speed of the vehicle 10 from the contrasting scale 46 without having to visually scan an entire speedometer scale range.

The color of the colored background 44 of the speedometer gauge 42 changes as the vehicle 10 speed changes. In one example, the colored background 44 is green at low vehicle 10 speeds, changes to yellow at intermediate speeds, and changes to red at high speeds. Preferably, the color change is gradual. That is, the color changes from green to green-yellow to yellow and from yellow to yellow-red to red. The use of changing green, yellow, and red color indicates the vehicle speed to the driver without the driver having to actually read the speed from the contrasting scale 46. Of course, the specific colors are merely examples. What is important is to use different colors and changing colors.

In another example, the colored background 44 changes color in response to a speed limit on the road that the vehicle 10 is traveling on. The speed limit information may be provided by a global positioning system, the driver, or other source via the controller 16. When the vehicle 10 is below the speed limit, the colored background 44 is green to indicate that the driver need not be concerned about the vehicle 10 speed. When the vehicle 10 speed nears the speed limit or is only about five m.p.h. above the speed limit, the colored background 44 changes to yellow to indicate to the driver that the vehicle 10 speed is close to the speed limit. When the vehicle 10 speed exceeds the speed limit by more than five m.p.h., the colored background 44 changes to red to warn the driver. Of course, the specific colors are merely examples. What is important is to use different colors and changing colors.

Alternatively, the color changes of the colored background 44 may be linked to driving conditions such as weather and daytime/nighttime wherein green indicates that speed is reasonable for the condition, yellow indicates that the speed might be of some concern for the driving condition, and red indicates that the speed might be too high for the driving condition. The driving condition information may be provided by a global positioning system, the driver, or other source via the controller 16. Of course, the specific colors are merely examples. What is important is to use different colors and changing colors.

In like manner to the speedometer gauge 42, a tachometer gauge 50 includes a colored background 52 to indicate an engine RPM A contrasting scale 54 scrolls relative to a pointer 56 which indicates the engine RPM. of the vehicle 10. The portion of the contrasting scale 54 that is displayed is only the significant portion. That is, only about a 2000 RPM range is displayed and not the entire tachometer scale from 0 RPM to 7000+RPM. This may help the driver to read the engine RPM of the vehicle 10 from the contrasting scale 54 without having to visually scan an entire tachometer scale range.

The controller 16 provides the engine RPM information to the instrument cluster 12 to be displayed by the tachometer gauge 50. When the engine RPM is low, the colored background 52 is green. When the engine RPM is higher, the colored background 52 changes to yellow. When the engine RPM is high, the colored background 52 changes to red to warn the driver. Preferably, the color change of the colored background 52 is gradual. The use of changing green, yellow, and red color indicates the engine RPM to the driver without the driver having to actually read the r.p.m. from the contrasting scale 54. Of course, the specific colors are merely examples. What is important is to use different colors and changing colors.

A gear telltale 58 indicates which gear the vehicle 10 is in. The gear telltale 58 displays a letter “P” to indicate that the vehicle 10 is in park gear. When the vehicle 10 is in drive gear, a letter “D” is displayed in the same illuminable area 60 as the “P”. That is, the various gear letters, “P”, “N”, “R”, and “D” that represent each possible gear share the same area on the instrument cluster 12 such that when one is displayed the others are not.

Additionally, the various gear letters may be arranged on a colored background 62, as illustrated in FIG. 3, to further distinguish the letters from each other. In one example, colored background 62 is green to represent a first drive gear and yellow to represent a second drive gear, such as for overdrive.

FIG. 3 illustrates a schematic front view of the instrument cluster 12 of FIG. 2 with different variable inputs from the controller 16. A text portion 72 of the instrument cluster 12 displays communication information for the driver. The communication information may include telephone numbers of incoming calls to a cellular telephone linked to the controller 16, the frequency setting of a vehicle radio, navigation directions, warnings that a door is ajar, directions to fasten seatbelts, directions to check engine, or other communication information provided by the controller 16.

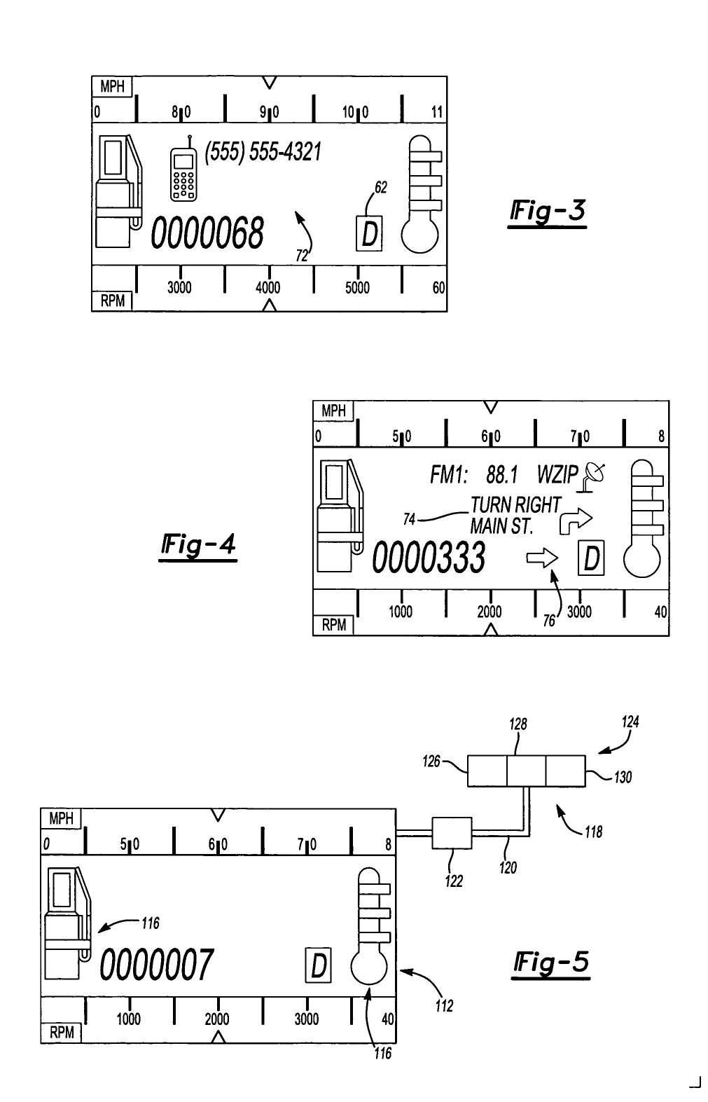

The instrument cluster 12 selectively displays the communication information in the text portion 72. In one example, when a telephone call is received, the text portion 72 displays the telephone number by replacing a display of a radio frequency setting. This change is of little or no consequence to the driver because the driver it is not likely that the driver needs to see the radio frequency when there is an incoming call. In another example, the text portion 72 displays navigation information 74, such as a direction to turn, simultaneously with other communications information, as illustrated in FIG. 4.

FIG. 4 illustrates a schematic front view of the instrument cluster 12 of FIG. 2 with different variable inputs. A turn signal portion 76 displays a first vehicle information graphic, a left turn arrow, when the driver signals to turn left and a second vehicle information graphic, a right turn arrow, when the driver signals to turn right. The right and left turn arrows are displayed in the same illuminable area. That is, the turn arrows share the same area on the instrument cluster 12 such that when one is displayed the other is not.

FIG. 5 illustrates a schematic front view of another embodiment of the inventive instrument cluster. The instrument cluster 112 includes a display portion 114 with vehicle information graphics 116 which convey vehicle condition information to the driver. A remote indicating system 118 communicates with the instrument cluster 112 through a connection 120 and a controller 122. The remote indicating system 118 includes three colored light indicators 124, preferably LED lights.

The colored light indicator 124 includes a green indicator 126, a yellow indicator 128, and a red indicator 130 that are positioned such that the driver can view each without taking his eyes off the road. Preferably, the colored light indicator 124 is positioned such that a driver sees the reflection of the LED on the windshield simultaneously with seeing the road. In one example, the green indicator 126 is illuminated under normal driving conditions. That is, illuminating the green indicator 126 qualitatively alerts the driver that all the vehicle information graphics 116 on the display portion 114 are green and that the vehicle conditions are satisfactory, i.e. the fuel level is near full, the temperature is normal, and the vehicle speed is not exceeding the speed limit. The driver need not look at the display portion 114 when the green indicator 126 is illuminated.

In another example, the yellow indicator 128 is illuminated when a vehicle information graphic 116 is yellow to qualitatively alert the driver to check the display portion 114 and that the vehicle conditions might be of some concern, i.e. the fuel level is nearing empty, the temperature is abnormal, or the vehicle speed is within five m.p.h. of the speed limit.

In another example, the red indicator 130 is illuminated when a vehicle information graphic 116 is red to qualitatively warn the driver that immediate attention is required and that the vehicle conditions require attention, i.e. the fuel level is very close to empty, the temperature is too hot, or the vehicle speed is exceeding the speed limit by more than five m.p.h. Of course, the specific colors and qualitative representations associated with each color are merely examples of conveying qualitative information with remote LED lights.

Additionally, the colored light indicators 124 may blink to alert the driver to check for new text information on the display portion 114 such as the posting of the next navigation direction or other new information. Of course, the specific colors are merely examples. What is important is to use different colors and changing colors.

Although a preferred embodiment of this invention has been disclosed, a worker of ordinary skill in this art would recognize that certain modifications would come within the scope of this invention. For that reason, the following claims should be studied to determine the true scope and content of this invention.

1. A vehicle display device comprising:
a variable input; and
a display including a vehicle information graphic having a color that changes in response to said variable input.

2. The device as recited in claim 1, wherein said color changes from a first color indicating a normal condition to a second color indicating a caution condition.

3. The device as recited in claim 1, further comprising a plurality of variable inputs and a plurality of vehicle information graphics, each of said plurality of vehicle information graphics having a color that changes in response to one of said plurality of variable inputs.

4. The device as recited in claim 1, further comprising an indicator remotely located from said display and in communication with said display, said indicator indicating whether a caution condition exists.

5. The device as recited in claim 1, wherein said variable input comprises a vehicle condition.

6. The device as recited in claim 1, wherein said variable input comprises a speed limit and said vehicle information graphic changes color in response to said speed limit.

7. The device as recited in claim 1, wherein said variable input comprises a fuel level and said vehicle information graphic changes color in response to said fuel level.

8. The device as recited in claim 1, further comprising a second variable input and a text display portion for displaying said second variable input.

9. The device as recited in claim 8, wherein said second variable input comprises communications information.

10. The device as recited in claim 1, wherein said vehicle information graphic is a symbol having a shape indicative of the information provided by the vehicle information graphic.

11. The device as recited in claim 1, further comprising a remote indicator indicating a change in said display.

12. A vehicle display device comprising:
a display receiving a variable input;
a first vehicle information graphic displayed in an illuminable area of said display when said variable input equals a first predetermined input;
a second vehicle information graphic displayed in said illuminable area when said variable input equals a second predetermined input.

13. The device as recited in claim 12, further comprising a third vehicle information graphic which changes color in response to a second variable input.

14. The device as recited in claim 12, wherein said first vehicle information graphic is not displayed when said second vehicle information graphic is displayed.

15. The device as recited in claim 12, wherein said first vehicle information graphic is a different color than said second vehicle information graphic.

16. The device as recited in claim 12, wherein said first vehicle information graphic comprises a non-numerical symbol.

17. A method of displaying vehicle information comprising the step of:
1) changing a color of a displayed vehicle information graphic in response to a variable input.

18. The method as recited in claim 17, wherein the step 1) includes changing the color from a first color indicating a normal condition to a second color indicating a caution condition.

19. The method as recited in claim 17, further comprising the step of continuously displaying the vehicle information graphic during operation of a vehicle.

20. The method as recited in claim 17, wherein the step 1) further includes changing the color of the displayed vehicle information graphic in response to a vehicle condition.

21. The method as recited in claim 17, including the step of changing between two or more colors on a remote indicator to indicate to a driver qualitative vehicle information represented by the vehicle information graphic.
